(19) United States
(12) Patent Application Publication
(10) Pub. No.: US 2026/0024305 A1
(43) Pub. Date: Jan. 22, 2026

(54) IMAGE RECOGNITION SYSTEM, IMAGE RECOGNITION METHOD AND IMAGE CAPTURING SUBSYSTEM

(71) Applicant: InnoLux Corporation, Miao-Li County (TW)

(72) Inventors: Shao-Yu CHIU, Miao-Li County (TW); Huang-Ren YAO, Miao-Li County (TW); Chong-Lin HUANG, Miao-Li County (TW); Tsun-Chi CHIU, Miao-Li County (TW)

(21) Appl. No.: 19/241,851

(22) Filed: Jun. 18, 2025

Related U.S. Application Data
(60) Provisional application No. 63/672,869, filed on Jul. 18, 2024.

(30) Foreign Application Priority Data
Dec. 20, 2024 (CN) 202411891214.2

(51) Int. Cl. G06V 10/75; G06K 7/14; G06T 7/60; G06T 7/90; G06V 10/40; G06V 20/62

(52) U.S. Cl. CPC G06V 10/751; G06K 7/1408; G06T 7/60; G06T 7/90; G06V 10/40; G06V 20/62; G06V 2201/09

(57) ABSTRACT

An image recognition system for recognizing a plurality of containers includes an image capturing component, a barcode recognition module, a container feature recognition module and a comparison module. The image capturing component is used to acquire a plurality of images, wherein each of the plurality of images includes a picture of the plurality of containers at a different angle. The barcode recognition module is used to acquire a first comparison result by recognizing barcodes on the plurality of containers in the plurality of images. The container recognition module is used to acquire a second comparison result by recognizing appearance features of the plurality of containers in the plurality of images. The comparison module is used to generate a final comparison result by comparing the first comparison result with the second comparison result.

### CROSS-REFERENCE TO RELATED APPLICATIONS

This application claims the benefit of filing date of U.S. Provisional Application Ser. No. 63/672,869 filed on Jul. 18, 2024 under 35 USC § 119(e)(1), and also claims the benefit of the Chinese Patent Application Serial Number 202411891214.2, filed on Dec. 20, 2024, the subject matters of which are incorporated herein by reference.

### BACKGROUND

### Field of the Application

The present application relates to an image recognition system, an image recognition method and an image capturing subsystem and, more particularly, to an image recognition system, an image recognition method and an imaging subsystem suitable for recognizing containers.

### Description of Related Art

Currently, the container placement device (such as but not limited to a medicine bottle placement device) generally utilizes two slide tables inside the device to accommodate multiple containers. By allowing the slide tables to move relative to each other in the same direction, workers can add containers to the slide tables from one location and perform operations such as container image capturing and recognition or machine dispensing at another location. However, when a camera is used to capture images of a container, since the distances between different slide tables and the camera are different, the image capturing position must be frequently adjusted or the camera focal length must be adjusted to maintain a better image capturing result. Therefore, as long as the placement of the container changes, the position of the camera must be adjusted, which consumes a lot of time. In addition, the contents of the container may be toxic and, when workers are refilling the material, toxic gases can easily leak out, resulting in a safety risk.

Therefore, there is a need to provide a novel image recognition system, image recognition method and image capturing subsystem to alleviate and/or obviate the above problems.

### SUMMARY

The present application provides an image recognition system for recognizing a plurality of containers, which comprises: an image capturing component for acquiring a plurality of images, wherein each image includes a picture of the plurality of containers at a different angle; a barcode recognition module for obtaining a first comparison result by recognizing barcodes on the plurality of containers in the plurality of images; a container feature recognition module for obtaining a second comparison result by recognizing appearance features of the plurality of containers in the plurality of images; and a comparison module for comparing the first comparison result with the second comparison result to detect whether the first comparison result and the second comparison result match so as to generate a final result.

The present application further provides an image recognition method for recognizing a plurality of containers, which is performed by an image recognition system including an image capturing component, a barcode recognition module, a container feature recognition module and a comparison module, and comprises the steps of: using the image capturing component to acquire a plurality of images, wherein each image includes a picture of the plurality of containers at a different angle; using the barcode recognition module to recognize barcodes on the plurality of containers in the plurality of images so as to obtain a first comparison result; using the container feature recognition module to recognize appearance features of the plurality of containers in the plurality of images so as to obtain a second comparison result; and using the comparison module to compare the first comparison result with the second comparison result so as to detect whether the first comparison result and the second comparison result match, thereby generating a final result.

The present application further provides an image capturing subsystem, which comprises: a rack assembly including a plurality of support racks arranged in an N-hedron, wherein N is a positive integer greater than or equal to 4, and each of the plurality of support racks has a plurality of carriers, on each of which a container is placed; a driving component for rotating the plurality of carriers to rotate the container; and an image capturing component for photographing the container placed on each of the plurality of carriers of one of the plurality of support racks.

Other novel features of the application will become more apparent from the following detailed description when taken in conjunction with the accompanying drawings.

### BRIEF DESCRIPTION OF DRAWINGS

FIG. 1A is a system architecture diagram of an image recognition system according to an embodiment of the present application;

FIG. 1B is a schematic diagram of an image capturing subsystem according to an embodiment of the present application;

FIG. 1C is a partial enlarged view of an image capturing subsystem according to an embodiment of the present application;

FIG. 2A is a schematic diagram of a clamping device and a container according to an embodiment of the present application;

FIG. 2B is a schematic diagram of a clamping device disposed on a carrier according to an embodiment of the present application.

FIG. 3A is a flowchart illustrating the steps of the drug preparation process according to an embodiment of the present application;

FIG. 3B is a flowchart illustrating the steps of the drug preparation process according to another embodiment of the present application;

FIG. 4 is a partial exploded view of a maintenance door according to an embodiment of the present application;

FIG. 5 is a schematic diagram of an application of an image capturing subsystem according to an embodiment of the present application;

FIG. 6 is a main flowchart of an image recognition method according to an embodiment of the present application;

FIG. 7 is a detailed flowchart of an image recognition method according to an embodiment of the present application;

FIG. 8 is a detailed flowchart of an image recognition method according to an embodiment of the present application; and

FIG. 9 is a detailed flowchart of an image recognition method according to an embodiment of the present application.

### DETAILED DESCRIPTION OF EMBODIMENT

Reference will now be made in detail to exemplary embodiments of the present disclosure, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present disclosure does not intend to distinguish between components that have the same function but have different names. In the following description and claims, words such as “containing” and “comprising” are open-ended words, and should be interpreted as meaning “including but not limited to”.

The terms, such as “about”, “equal to”, “equal” or “same”, “substantially”, or “approximately”, are generally interpreted as within 20% of a given value or range, or as within 10%, 5%, 3%, 2%, 1%, or 0.5% of a given value or range.

In the specification and claims, unless otherwise specified, ordinal numbers, such as “first” and “second”, used herein are intended to distinguish elements rather than disclose explicitly or implicitly that names of the elements bear the wording of the ordinal numbers. The ordinal numbers do not imply what order an element and another element are in terms of space, time or steps of a manufacturing method. Thus, what is referred to as a “first element” in the specification may be referred to as a “second element” in the claims.

In the present application, the expressions “the given range is from the first numerical value to the second numerical value” and “the given range falls within the range from the first numerical value to the second numerical value” indicate that the given range includes the first numerical value, the second numerical value, and other values between the first and second numerical values.

In addition, the image recognition system disclosed in the present application may be applied to the electronic device itself, the application of the electronic device or the manufacturing process of the electronic device. The electronic device may include automation equipment, clamping devices, mobile platform picking devices, computing devices, mechanical equipment, drug preparation equipment, exposure devices, printing devices, three-dimensional printing devices, automotive devices, image capturing devices, assembly devices, backlight devices, antenna devices, tiled devices, touch electronic devices, curved electronic devices or free shape electronic devices, but not limited thereto. The display device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy, or ultrasound, but not limited thereto. The tiled device may include, for example, a display tiled device or an antenna tiled device, but not limited thereto. It should be noted that the electronic device may be any arrangement or combination of the aforementioned, but not limited thereto. In addition, the electronic device may be a bendable or flexible electronic device. It should be noted that the electronic device may be any arrangement or combination of the aforementioned, but not limited thereto. In addition, the shape of the electronic device may be rectangular, circular, polygonal, a shape with curved edges, or other suitable shapes. The electronic device may have peripheral systems such as a driving system, a control system, a light source system, a shelf system, etc. to support a display device, an antenna device, or a tiled device. The electronic device may include, for example, electronic components, liquid crystal, light emitting diode, quantum dot (QD), fluorescence, phosphor, other suitable display media, or a combination thereof, but not limited thereto. The electronic components may include passive components and active components, such as capacitors, resistors, inductors, diodes, transistors, etc. The diode may include a light emitting diode or a photodiode. The light emitting diode may include, for example, an organic light emitting diode (OLED), a sub-millimeter light emitting diode (mini LED), a micro light emitting diode (micro LED) or a quantum dot light emitting diode (quantum dot LED, including QLED, QDLED), a light emitting diode of a flexible display, or other suitable materials, or a combination thereof, but not limited thereto.

It is noted that, in the following embodiments, without departing from the spirit of the present disclosure, the features in different embodiments may be replaced, reorganized, and mixed to complete other embodiments. As long as the features of the various embodiments do not violate or conflict the spirit of the invention, they may be mixed and matched arbitrarily.

Unless otherwise defined, all terms (including technical and scientific terms) used herein have the same meaning as commonly understood by those skilled in the art to which the present disclosure belongs. It can be understood that these terms, such as those defined in commonly used dictionaries, should be interpreted as having meanings consistent with the background or context of the related technology and the present disclosure, and should not be interpreted in an idealized or overly formal manner, unless otherwise specified in the embodiments of the present disclosure.

In addition, the term “adjacent” in the specification and claims is used to describe mutual proximity, and does not necessarily mean mutual contact.

In addition, the description of “when . . . ” or “while . . . ” in the present disclosure means “now, before, or after”, etc., and is not limited to occurrence at the same time. In the present disclosure, the similar description of “disposed on” or the like refers to the corresponding positional relationship between the two elements, and does not limit whether there is contact between the two elements, unless specifically limited. Furthermore, when the present disclosure recites multiple effects, if the word “or” is used between the effects, it means that the effects can exist independently, but it does not exclude that multiple effects can exist at the same time.

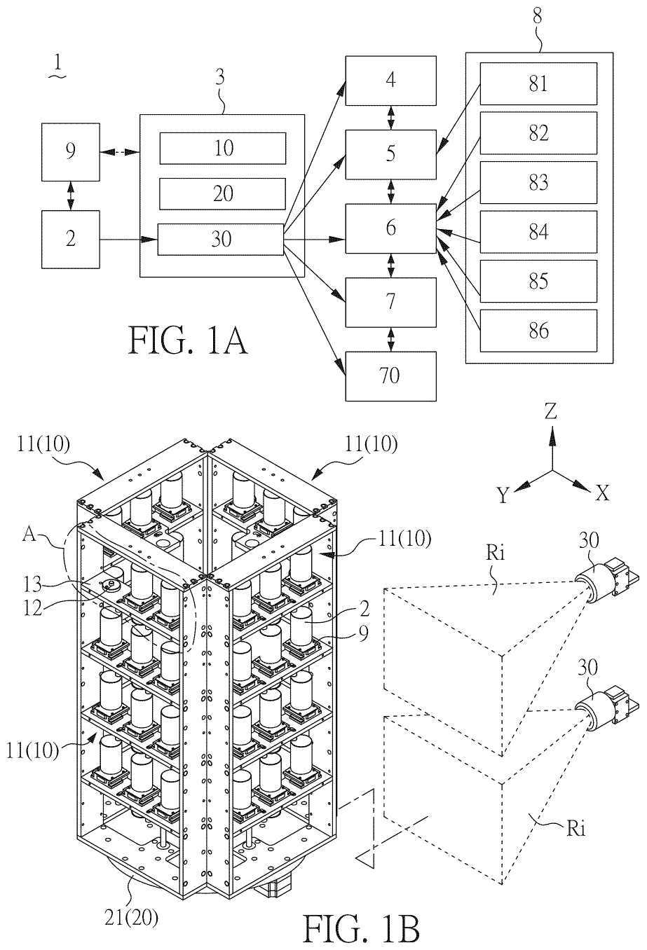

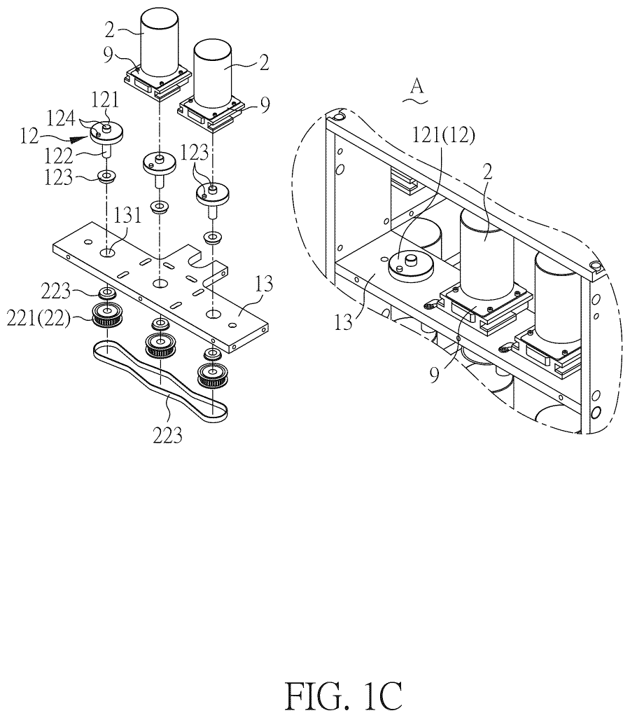

FIG. 1A is a schematic diagram of an image recognition system 1 according to an embodiment of the present application, wherein the image recognition system 1 is suitable for recognizing a plurality of containers 2 and may be assembled in an electronic device. As shown in FIG. 1A, the image recognition system 1 at least includes an image capturing subsystem 3, a barcode recognition module 5, a container feature recognition module 6 and a comparison module 7. In addition, the image recognition system 1 may further include an image correction module 4, and the image recognition system 1 may further include a database 8. In one embodiment, the image capturing subsystem 3 may include a rack assembly 10, a driving component 20 and an image capturing component 30. In one embodiment, the database 8 may include at least one of a barcode database 81, a front image database 82, a color database 83, a size database 84, and a detail feature database 85, but it is not limited thereto. In addition, the image recognition system 1 may be operated with a clamping device 9, wherein the clamping device 9 may be used to clamp the container 2, and the clamping device 9 may be set on the rack assembly 10, so that the containers 2 may be placed on the rack assembly 10, but it is not limited thereto. In addition, in one embodiment, the image recognition system 1 may further include an image segmentation module 70.

The image capturing component 30 of the image capturing subsystem 3 may be used to obtain a plurality of images, and each image includes a picture of at least one container 2 at a different angle, wherein “different angle” correspond to the rotation angle of the container 2 itself in the horizontal direction. For example, referring to FIG. 1B at the same time, each container 2 itself may be rotated around the Z direction relative to the rack assembly 10, and the image capturing component 30 may capture images of the container 2 at different rotation angles, while it is not limited thereto. In one embodiment, the image capturing device 30 may capture an image every time the container 2 rotates five degrees. Thus, the image capturing device 30 may obtain seventy-two images for one container 2, but it is not limited thereto. The barcode recognition module 5 may be used to recognize the barcode on the container 2 in the image, so as to obtain a first comparison result. The container feature recognition module 6 may be used to recognize the appearance features of the container 2 in the image, so as to obtain a second comparison result. The comparison module 7 may be used to compare whether the first comparison result and the second comparison result are consistent, so as to generate a final result. In addition, in one embodiment, after the image capturing component 30 acquires an image, the image segmentation module 70 may be used to segment each container 2 in the image to form a container image, and the barcode recognition module 5 and the container feature recognition module 6 may individually recognize the container image of each container 2, while it is not limited thereto. Thus, the image recognition system 1 may be used to recognize the type of the container 2 or to detect the type of the contents of the container 2, while it is not limited thereto.

Next, the details of each component are described.

First, the details of the image capturing subsystem 3 are described. FIG. 1B is a schematic diagram of an image capturing subsystem 3 according to an embodiment of the present application, FIG. 1C is a partial enlarged diagram of the image capturing subsystem 3 according to an embodiment of the present application, and please refer to FIG. 1A at the same time, wherein FIG. 1C corresponds to a local area A in FIG. 1B.

Regarding the rack assembly 10, as shown in FIG. 1B and FIG. 1C, the rack assembly 10 of the image capturing subsystem 3 may include a plurality of support racks 11, and the plurality of support racks 11 may be arranged into an N-hedron (that is, a solid shape with N flat surfaces), where N is a positive integer greater than or equal to 4 (4≤N). In one embodiment, N may be an even number greater than or equal to 4; for example, the plurality of support racks 11 may be arranged into a tetrahedron, a hexahedron, an octahedron, and so on, while it is not limited thereto. Each support rack 11 may have a plurality of carriers 12. More specifically, each support rack 11 may have a plurality of shelves 13, and a plurality of carriers 12 are arranged on each shelf 13. The shelves 13 of each support rack 11 may be arranged, for example, along the Z direction, wherein adjacent shelves 13 are separated from each other along the Z direction, and the carriers 12 on each shelf 13 are arranged, for example, along a direction substantially perpendicular to the Z direction (for example, the X direction or the Y direction, while it is not limited thereto). Each carrier 12 may be used to have a container 2 placed on it, wherein the container 2 may be placed on the carrier 12 by the clamping device 9.

Regarding the driving component 20, in one embodiment, the driving component 20 may include a main rotating shaft (not shown). The main rotating shaft of the driving component 20 may be pivotally connected to a bottom base 21, and the main rotating shaft may be fixed to the rack assembly 10. Therefore, when the main rotating shaft of the driving component 20 rotates relative to the bottom base 21, the driving component 20 may drive the rack assembly 10 to rotate relative to the bottom base 21, for example, so that one of the support racks 11 of the rack assembly 10 faces the image capturing component 30, while it is not limited thereto. As a result, the details of the rack assembly 10 can be understood.

In addition, as shown in FIG. 1C, the driving component 20 may include a plurality of sub-driving components 22, and each sub-driving component 22 may be used in conjunction with a carrier 12 on a shelf 13. In one embodiment, the carrier 12 may have a carrier plane 121 and a carrier rotation shaft 122, wherein the carrier rotation shaft 122 may be disposed directly below the carrier plane 121, but it is not limited thereto. The shelf 13 may include a plurality of holes 131. The size of the hole 131 may be larger than the carrier rotation shaft 122 and smaller than the carrier plane 121. Therefore, the carrier rotation shaft 122 may pass through the hole 131, and the carrier plane 121 is allowed to be attached to the shelf 13, while it is not limited thereto. The sub-driving component 22 may be, for example, a timing wheel, and may be used in conjunction with a bearing 222, wherein, for example, in the Z direction, the carrier rotation shaft 122 may pass through a hole 131 of the shelf 13 through a bearing 123, and may be combined with the sub-driving component 22 below the shelf 13 through another bearing 222. In addition, a plurality of sub-driving components 22 under the same shelf 13 may be sleeved with a timing belt 223.

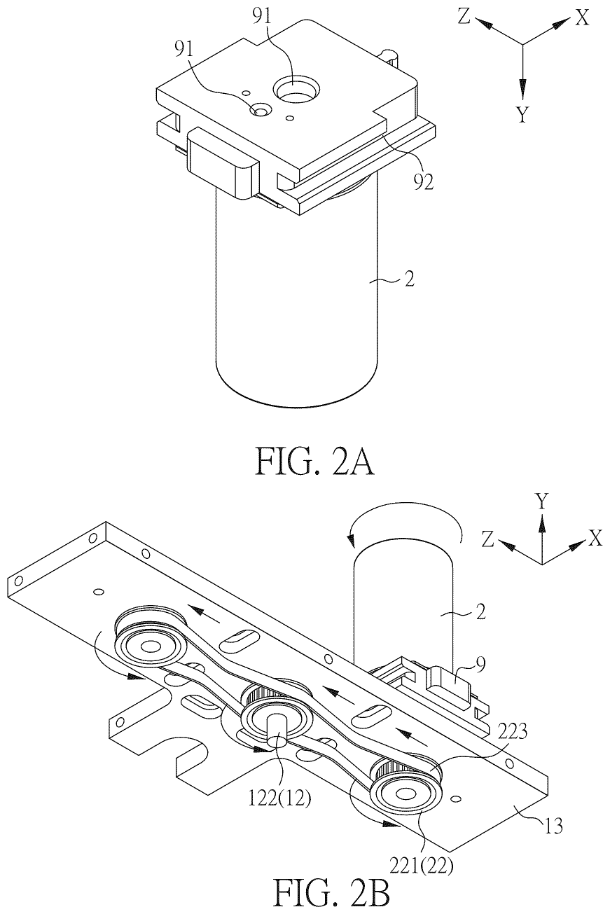

Next, please refer to FIG. 1C and FIG. 2A at the same time, wherein FIG. 2A is a schematic diagram of a clamping device 9 and a container 2 according to an embodiment of the present application. As shown in FIG. 1C and FIG. 2A, each carrier 12 may have at least one positioning member 124 on the carrier plane 121, and the clamping device 9 may have at least one positioning hole 91 corresponding to the at least one positioning member 124, whereby the clamping device 9 may be disposed on the carrier 12 for being positioned. In one embodiment, when the positions of the positioning members 124 on the carrier plane 121 of each carrier 12 are set to be consistent, each clamping device 9 may be set on the carrier 12 at a consistent position.

Next, please refer to FIG. 1B to FIG. 2B at the same time, wherein FIG. 2B is a schematic diagram of a clamping device 9 disposed on a carrier 12 according to an embodiment of the present application. As shown in FIG. 2B, in one embodiment, when the clamping device 9 clamps the container 2 and is set on the carrier 12, the carrier rotation shaft 122 of at least one carrier 12 protrudes from the sub-driving component 22 and may be connected to an external power source (not shown). Therefore, when the external power source provides power to rotate the carrier rotation shaft 122, the sub-driving component 22 fixed to the carrier rotation shaft 122 may rotate relative to the hole 131 of the shelf 13 and may drive other sub-driving components 22 to rotate together through the timing belt 223. In addition, the rotation of the carrier rotation shaft 122 and the sub-driving component 22 may also drive the carrier 12 to rotate together, so that the clamping device 9 and the container 2 disposed on the carrier 12 rotate, while it is not limited thereto. In addition, by disposing the timing belt 223, the sub-driving components 22 on the same timing belt 223 may rotate at the same speed and in the same direction, which is beneficial for image capturing and subsequent image recognition. As a result, the details of the driving component 20 can be understood.

Regarding the image capturing component 30, please refer to FIG. 1B again. In one embodiment, the image capturing component 30 may be disposed adjacent to one side of the rack assembly 10. In one embodiment, the relative position between the image capturing component 30 and the rack assembly 10 may be set such that when the first driving member 21 rotates the rack assembly 10, the front side of one of the support racks 11 of the rack assembly 10 faces the image capturing component 30, but it is not limited thereto. In one embodiment, when the front side of one of the support racks 11 of the rack assembly 10 faces the image capturing component 30, an image capturing range Ri of the image capturing component 30 may cover all containers 2 on at least one shelf 13 of the one of the support racks 11, but it is not limited thereto. In one embodiment, the image capturing subsystem 3 may include at least one image capturing component 30, wherein, when the front side of one of the support racks 11 of the rack assembly 10 faces the image capturing component 30, the image capturing range Ri of the image capturing component 30 may cover all containers 2 on the plurality of shelves 13. In another embodiment, the image capturing subsystem 3 includes a plurality of image capturing components 30, wherein the image capturing range Ri of each image capturing component 30 may correspond to a plurality of different shelves 13, but it is not limited thereto. In one embodiment, the N-hedron formed by the arrangement of the support racks 11 may be rotated relative to the bottom base 21. When each support rack 11 is rotated to a specific position, for example, facing the image capturing component 30 with the front side, the shortest distance between each support rack 11 and the image capturing component 30 in the horizontal direction (for example, but not limited to, the X direction or the Y direction) may be equal. Therefore, it is not necessary to readjust the relative position between the image capturing component 30 and the rack assembly 10 every time the rack assembly 10 is rotated, which may shorten the image capturing time and improve efficiency. In one embodiment, the image capturing component 30 may be, for example, a video camera, a scanner, a camera or other photosensitive components with an image capturing function, but it is not limited thereto. Therefore, when the present application is used, there is no need to adjust the position of the image capturing component 30, which is convenient to use. Accordingly, the details of the image capturing component 30 can be understood.

Next, the details of the image correction module 4, the barcode recognition module 5, the container feature recognition module 6, the comparison module 7 and the image segmentation module 70 are described, and please refer to FIG. 1A again. In one embodiment, the image correction module 4, the barcode recognition module 5, the container feature recognition module 6, the comparison module 7 and/or the image segmentation module 70 may be, for example, functional modules, and the functions of these modules may be implemented by at least one processor executing instructions in at least one computer program product stored in at least one non-transitory computer-readable medium, but it is not limited thereto. In one embodiment, the processor for implementing the modules may be disposed in a computer, a mobile device, a cloud server or other electronic devices equipped with a processor. In one embodiment, the electronic device may have a communication function so that the image correction module 4, the barcode recognition module 5, the container feature recognition module 6, the comparison module 7 and/or the image segmentation module 70 may communicate with the image capturing component 30 or the database 8 by wired transmission or wireless transmission, but it is not limited thereto. In one embodiment, the image correction module 4, the barcode recognition module 5, the container feature recognition module 6, the comparison module 7 and/or the image segmentation module 70 may receive images from the image capturing component 30.

Furthermore, in one embodiment, the recognition process of the container feature recognition module 6 may be achieved, for example, by a processor executing a predetermined step process, but in another embodiment, the container feature recognition module 6 may also be an artificial intelligence model, such as a trained machine learning model, and has the ability to automatically recognize objects in an image, while it is not limited thereto. In one embodiment, when the container feature recognition module 6 is an artificial intelligence model, it may be arranged on a computer or a cloud server, while it is not limited thereto.

Next, the details of the database 8 will be described. In one embodiment, the database 8 may be stored in a computer, a mobile device, a cloud server or other electronic devices with a storage device, wherein the storage device may be, for example, a hard drive, a memory, a cloud hard drive, etc., but it is not limited thereto. In one embodiment, the barcode recognition module 5 and the container feature recognition module 6 may be electrically connected or communicate with the database 8, so that the barcode recognition module 5 and the container feature recognition module 6 may obtain data in the database 8. In one embodiment, the barcode database 81 may store a plurality of barcode data, wherein each barcode data may correspond to the identity information of a container 2 (for example, a medicine bottle) or the information of the contents of the container 2 (for example, the information of the contents may be further converted into the identity information of the container 2). For example, the barcode may be a one-dimensional barcode or a two-dimensional barcode, and the barcode may correspond to the information of the contents of the container 2, thereby obtaining the identity information of the container 2, while it is not limited thereto. In one embodiment, the front image database 82 may store data of front images of a plurality of containers 2, wherein the data of each front image may correspond to the identity information of a container 2. Here, the “front image” is, for example, the image of the side of the container 2 with a label, but it is not limited thereto. In one embodiment, the color database 83 may store color distribution data of a plurality of containers 2, wherein each color distribution data may correspond to the identity information of a container 2, and the “color distribution” here refers to, for example, the distribution of the main colors on the container 2 or the proportion of the main colors on the container 2, while it is not limited thereto. In one embodiment, the size database 84 may store data on the sizes of a plurality of containers 2, wherein each size data may correspond to the identity information of a container 2, but it is not limited thereto. In one embodiment, the detail feature database 85 may store data on the detail features of a plurality of containers 2, wherein each detail feature data may correspond to the identity information of a container 2. The “detail feature” here may be, for example, the feature of a certain area on the container 2, such as the details of the text or label on a certain area. It should be noted that the detail feature of the “text” or “label” here is mainly based on the shape feature, rather than the content of the text or label, while it is not limited thereto. It should be noted that the aforementioned “front image” corresponds to the entire container 2, such as covering the entire area of the bottle head, bottleneck and bottle body, while the “detail features” correspond to one area of the container 2, such as a partial area of the bottle body or a partial area of the bottle head.

In addition, in one embodiment, when the container feature recognition module 6 is an artificial intelligence model, the database 8 may further include an artificial intelligence model database 86 to store various data required by the artificial intelligence model, such as data required for the training stage, various data established through training (such as various judgment logics) and/or data required for the actual use stage, etc., while it is not limited thereto.

It should be noted that the database types of the database 8 may be increased or decreased according to the requirements.

Furthermore, in one embodiment, the barcode recognition module 5 may obtain an image from the image capturing component 30 and compare the barcode on at least one container 2 of the image with the data in the barcode database 81, and then recognize the identity information of the at least one container 2, while it is not limited thereto. In one embodiment, the container feature recognition module 6 may obtain images from the image capturing component 30 and compare the front image of the at least one container 2 in the image with the data in the front image database 82 so as to recognize the identity information of the at least one container 2, while it is not limited thereto. In one embodiment, the container feature recognition module 6 may obtain an image from the image capturing component 30 and compare the color distribution of the at least one container 2 in the image with the data in the color database 83 to recognize the identity information of the at least one container 2, while it is not limited thereto. In one embodiment, the container feature recognition module 6 may obtain an image from the image capturing component 30 and compare the size of the at least one container 2 in the image with the data in the size database 84 to recognize the identity information of the at least one container 2, while it is not limited thereto. In one embodiment, the container feature recognition module 6 may obtain an image from the image capturing component 30 and compare the details of the at least one container 2 in the image with the data in the detail feature database 85 to recognize the identity information of the at least one container 2, while it is not limited thereto. Here, “comparison” may be, for example, but not limited to, comparing images acquired by the image capturing component 30 with all data in a specific database, and the comparison results of images with all data in a specific database may be converted separately to form a numeric value, where the higher the value means the closer the comparison results, so that the most consistent result can be found. Furthermore, if the values of all comparison results are lower than a predetermined threshold, it means that the corresponding result cannot be found, while it is not limited thereto.

In addition, in one embodiment, when the container feature recognition module 6 is an artificial intelligence model, the container feature recognition module 6 may automatically analyze the type of the container in the image according to the result of its machine learning, but it is not limited thereto. In one embodiment, the container feature recognition module 6 may be trained through a large number of images of various containers 2 during training, and when the training is completed, as long as one image is input into the container feature recognition module 6, the container feature recognition module 6 may automatically determine the type of container 2 according to the judgment logic established during training, while it is not limited thereto.

Accordingly, the details of the components of the image recognition system 1 can be understood.

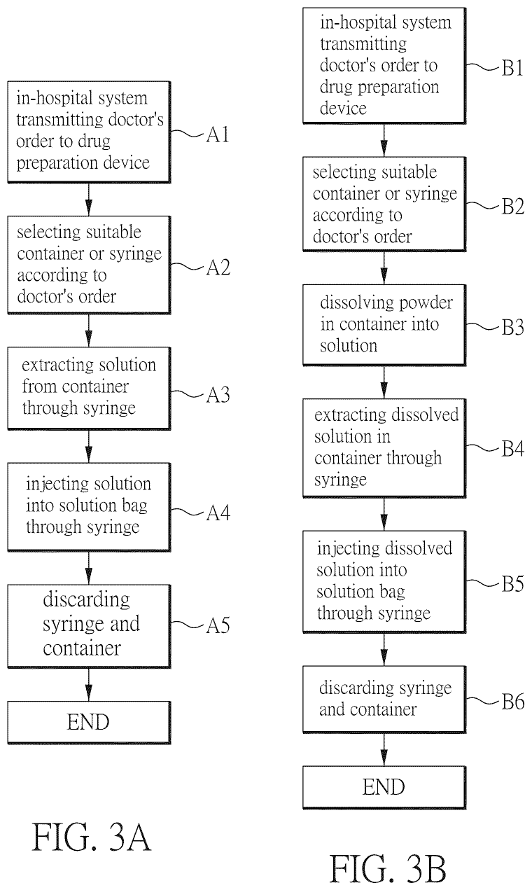

The image recognition system 1 of the present application may be applied to the process of drug preparation. FIG. 3A is a flowchart illustrating the steps of the operation process of the drug preparation device according to an embodiment of the present application, and please refer to FIG. 1A to FIG. 2B at the same time. As shown in FIG. 3A, step A1 is first executed, in which the drug preparation device receives a doctor's order (for example, a prescription) transmitted by an in-hospital system of the hospital. Then, step A2 is executed, in which the operator of the drug preparation device or the drug preparation device itself (if the drug preparation device has an automated function) may select a suitable container 2 or syringe according to the doctor's order, wherein the container may contain a specific solution. Then, step A3 is executed, in which the drug preparation device (if the drug preparation device has an automated function) may extract the solution from the container 2 through the syringe. Then, step A4 is executed, in which the drug preparation device itself (if the drug preparation device has an automated function) may inject the solution into the solution bag through the syringe. Then, step A5 is executed, in which the drug preparation device itself (if the drug preparation device has an automated function) discards the syringe and the container 2. In the above steps, the image recognition system 1 may be used in step A2, for example, to recognize the type of container 2 on the rack assembly 10, so that the automated equipment may select the container 2 corresponding to the doctor's order or provide the container 2, while it is not limited thereto.

FIG. 3B is a flowchart illustrating the steps of the operation process of a drug preparation device according to another embodiment of the present application, and please refer to FIG. 1A to FIG. 2B at the same time. As shown in FIG. 2B, step B1 is first executed, in which the drug preparation device receives a doctor's order (for example, a prescription) transmitted by an in-hospital system of the hospital. Then, step B2 is executed, in which the operator of the drug preparation device or the drug preparation device itself (if the drug preparation device has an automated function) selects a suitable container 2 or syringe according to the doctor's order, wherein the container may contain specific powder (for example, drug). Then, step B3 is executed, in which the operator of the drug preparation device or the drug preparation device itself (if the drug preparation device has an automated function) dissolves the powder in the container into a solution. Then, step B4 is executed, in which the drug preparation device itself (if the drug preparation device has an automated function) extracts the dissolved solution in the container through the syringe. Then, step B5 is executed, in which the drug preparation device itself (if the drug preparation device has an automated function) injects the dissolved solution into the solution bag through the syringe. Then, step B6 is executed, in which the drug preparation device itself (if the drug preparation device has an automated function) discards the syringe and the container 2. In the above steps, the image recognition system 1 may be used in step B2, but it is not limited thereto. In addition, the rack assembly 10 and the driving component 20 in the image capturing subsystem 3 may also be used for step B3. For example, the driving component 20 may rotate the support rack 11, on which the container 2 required for step B3 is placed, to face the staff or other automated equipment, so as to allow the staff or other automated equipment to execute the content of step B3 on the rack assembly 10, but it is not limited thereto.

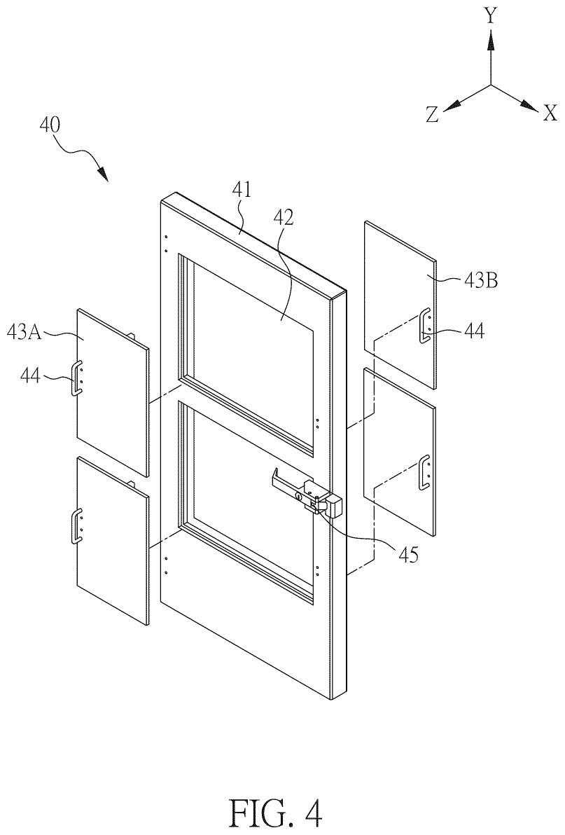

In addition, the rack assembly 10 of the present application may also have a special design for ease of use, for example, making the execution of step B3 of FIG. 3B smoother, but it is not limited thereto. FIG. 4 is a partial exploded view of an isolation door 40 according to an embodiment of the present application, and please refer to FIG. 1A to FIG. 3B at the same time.

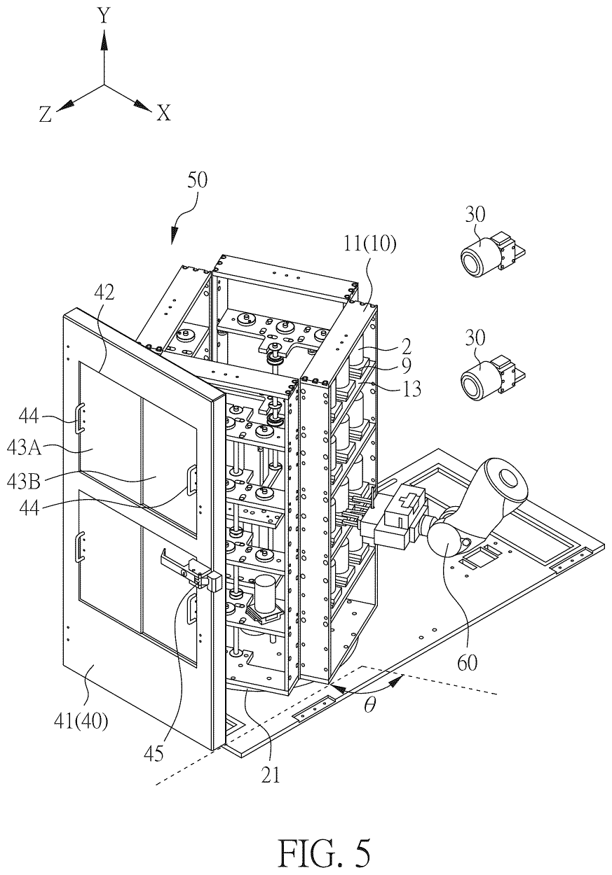

As shown in FIG. 4, the image capturing subsystem 3 may further include an isolation door 40 disposed on one side adjacent to the rack assembly 10. For example, the rack assembly 10 may actually be disposed in a chamber 50 (shown in FIG. 5), and the chamber 50 is provided with an isolation door 40. When the isolation door 40 is opened, the chamber 50 may be in communication with the external space. When the isolation door 40 is closed, the chamber 50 may be in a closed state, while it is not limited thereto. The isolation door 40 may include a body 41 and at least one window 42, and the at least one window 42 may be provided with a first window piece 43A and a second window piece 43B. The first window piece 43A and the second window piece 43B may be each provided with a handle 44. The first window piece 43A and the second window piece 43B may move or slide, for example, in the X direction. For example, the first window piece 43A may move along the X direction, or the second window piece 43B may move in the opposite direction of the X direction, so that a portion of the at least one window 42 is not blocked by the first window piece 43A or the second window piece 43B, and a portion of the rack assembly 10 is exposed, whereby personnel may contact the rack assembly 10 through the unblocked portion of the window 42, but it is not limited thereto. In addition, the isolation door 40 may also include a door lock 45 disposed on the body 41, wherein the door lock 45 may be configured to be opened only when the rack assembly 10 needs to be repaired or in an emergency, but it is not limited thereto. In one embodiment, the first window piece 43A and the second window piece 43B may be made of a transparent material, such as glass, acrylic, or a transparent conductive film (indium tin oxide, ITO), while it is not limited thereto. In one embodiment, the first window piece 43A and the second window piece 43B may also be made of opaque material.

FIG. 5 is a schematic diagram of a usage scenario of the image capturing subsystem 3 according to an embodiment of the present application, and please refer to FIG. 1A to FIG. 4 at the same time. As shown in FIG. 5, the rack assembly 10 and the driving component 20 may be disposed in the chamber 50 (FIG. 5 only shows a partial space), the image capturing component 30 may be disposed inside or outside the chamber 50, and a robotic arm 60 of other equipment may be disposed in the chamber 50.

In one embodiment, when the clamping device 9 and the container 2 clamped therein need to be placed on the carrier 12 of the rack assembly 10 (shown in FIG. 1B and FIG. 1C), a portion of the window 42 is opened by moving the first window piece 43A or the second window piece 43B, so that a portion of the carrier 12 on the bracket 10 is exposed at the opened portion of the window 42, thereby allowing the clamping device 9 and the container 2 clamped therein to be placed on the carrier 12. By designing the isolation door 40, the first window 43A and the second window 43B, only a small area of the chamber 50 will be opened each time. Therefore, even if there are volatiles in the container 2, the volatiles are not likely to leak out of the chamber 50, thereby improving safety, while it is not limited thereto.

In one embodiment, the image capturing component 30 faces the isolation door 40. In other words, an included angle between the image capturing component 30 and the isolation door 40 is 180 degrees. When the image capturing component 30 needs to photograph the container 2 on one of the support racks 11 of the rack assembly 10, the rack assembly 10 itself may be rotated relative to the base 21, so that one of the support racks 11 rotates 180 degrees from facing the isolation door 40 to be oriented toward the image capturing component 30. In one embodiment, the sub-driving component 22 may also rotate the carrier 12 so that the container 2 at various angles may face the image capturing component 30 for facilitating image capturing. In addition, after the image capturing component 30 captures the image, the acquired image may be transmitted to the barcode recognition module 5, the container feature recognition module 6 and the comparison module 7, as shown in FIG. 1A, so as to recognize the container 2.

In this embodiment, when the robotic arm 60 needs to pick up a container 2 on one of the support racks 11 (for example, according to the content of a doctor's order), the rack assembly 10 itself may rotate so that one of the support racks 11 may face the robotic arm 60. At this moment, an angle θ may be formed between the support rack 11 facing the robotic arm 60 and the isolation door 40, wherein 0 may be greater than or equal to 120 degrees and less than or equal to 160 degrees to reduce the impact of the robotic arm 60 on the image capturing component 30, and the robotic arm 60 may clamp the groove 92 (shown in FIG. 2A) on the clamping device 9 with the container 2, and then remove the clamping device 9 from the carrier 12, while it is not limited thereto.

Accordingly, the usage of the image capturing subsystem 3 can be understood.

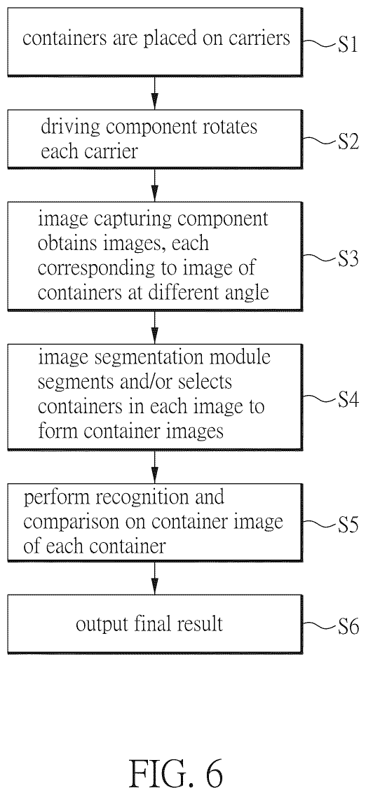

After the image capturing component 30 acquires the image, the image recognition system 1 may execute an image recognition method to recognize the container 2 in the image. FIG. 6 is a main flowchart of an image recognition method according to an embodiment of the present application, and please refer to FIG. 1A to FIG. 5 at the same time.

As shown in FIG. 6, step S1 is first executed, in which a plurality of containers 2 are placed on a plurality of carriers 12. Then, step S2 is executed, in which each sub-driving component 22 of the driving component 20 rotates each carrier 12. Then, step S3 is executed, in which the image capturing component 30 obtains a plurality of images, each image corresponding to a picture of the plurality of containers 2 at a different angle. Then, step S4 is executed, in which the image segmentation module 70 segments and/or selects a plurality of containers 2 in each image to form a plurality of container images. Then, step S5 is executed to perform recognition and comparison on the container image of each container 2. Then, step S6 is executed to output the final result.

Regarding steps S1 to S3 and step S6, reference may be made to the description of the aforementioned embodiment, and thus will not be described in detail. Regarding step S4, in one embodiment, the image segmentation module 70 may use various suitable methods to segment and/or select multiple containers 2 in the image, such as binarization, clustering, histogram method, edge detection, region growing method, level set method, or wavelet transform method, etc., but it is not limited thereto. In one embodiment, the plurality of images obtained in step S3 may be, for example, images of the same set of containers 2 at different rotation angles. Since the position of each container 2 in the different images remains fixed, when performing image segmentation or selection in step S4, the image recognition system 1 may track the segmented or selected image of each container 2 according to the position of each container 2 in the image; that is, the image recognition system 1 detect which multiple container images correspond to each container 2.

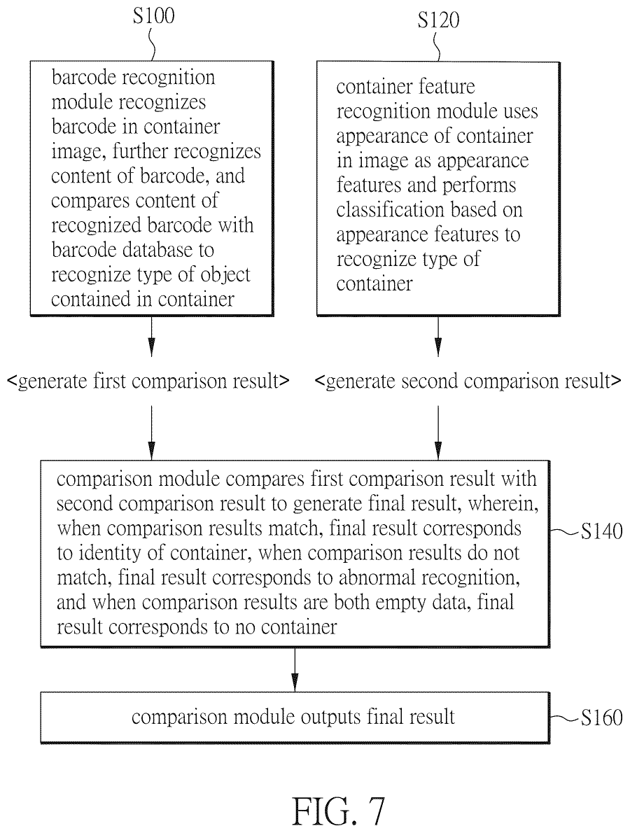

Regarding the details of step S5, FIG. 7 is a detailed flowchart of an image recognition method according to an embodiment of the present application, which is used to illustrate the details of step S5 where the recognition of a single container image is taken as an example, and please also refer to FIG. 1A to FIG. 6. In FIG. 7, the container feature recognition module 6 is, for example, a trained artificial intelligence model, but it is not limited thereto.

As shown in FIG. 7, step S100 is first executed, in which the barcode recognition module 5 recognizes the barcode in the container image to obtain a first comparison result, wherein the barcode recognition module 5 may recognize whether there is a barcode in the container image, and if so, the recognized barcode is compared with the data in the barcode database 81 to generate a first comparison result. Furthermore, when the comparison is successful, the first comparison result may include information related to the identity information of the container 2, such as but not limited to the name of the container content (for example, the name of the drug). When the comparison fails, the first comparison result may include empty data. In addition, if the barcode recognition module 5 recognizes that there is no barcode in the container image, the barcode recognition module 5 may also output empty data as the first comparison result, but it is not limited thereto. Then, step S120 is executed, in which the container feature recognition module 6 (trained artificial intelligence model) recognizes the appearance features of the container image to obtain a second comparison result. For example, the appearance features may be analyzed to recognize the identity information of the container 2 and generate a second comparison result, wherein, when the recognition is successful, the second comparison result may include information related to the identity information of the container 2, and when the recognition fails, the second comparison result may include empty data. Then, step S140 is executed, in which the comparison module 7 compares the first comparison result and the second comparison result to generate a final result, wherein, when the first comparison result matches the second comparison result and neither of the first and second comparison results is empty data, the final result may include a message related to the identity information of the container 2. When the first comparison result does not match the second comparison result, the final result may include a message of abnormal recognition, and when the first comparison result and the second comparison result are both empty data, the final result may include a message of no container. Then, step S160 is executed, in which the comparison module 7 outputs the final result.

In one embodiment, when the barcode recognition module 5 compares the barcode in the container image with the data in the barcode database 81, the barcode recognition module 5 may compare the barcode in the container image with a plurality of data in the barcode database 81 and select the most matching one of the data as the first comparison result, but it is not limited thereto. Furthermore, the barcode recognition module 5 may preset a threshold value. When the similarity of the comparison is higher than or equal to the threshold value, the data will be used as the content of the first comparison result. In other words, if the similarity of all comparisons is lower than the threshold value, the empty data will be used as the content of the first comparison result, while it is not limited thereto.

In one embodiment, since each carrier 12 rotates, the same container 2 may have a plurality of images at different rotation angles, wherein the container 2 at certain rotation angles may lack recognizable information, so that the final result corresponding to the rotation angle may be an abnormal recognition message or a message of no container, while the container 2 at certain rotation angles may have sufficient information, so that the final result corresponding to the rotation angle may be a message related to the identity information of the container 2. At this moment, the electronic device 1 may output the message related to the identity information of the container 2 as the actual final result, while it is not limited thereto.

Accordingly, the details of the image recognition method can be understood.

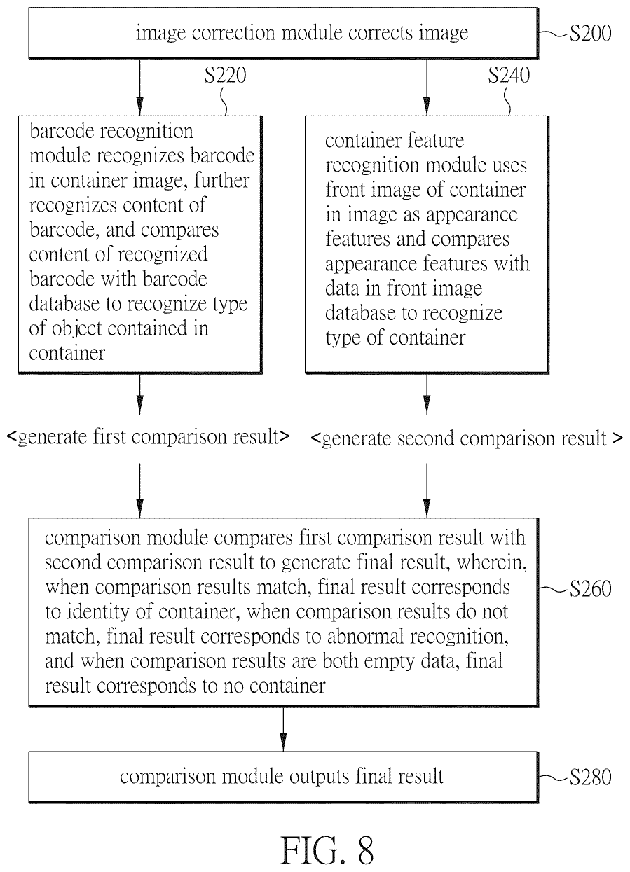

FIG. 8 is a detailed flowchart of an image recognition method according to another embodiment of the present application, which is used to illustrate the details of recognizing one of the container images in step S5, and please refer to FIG. 1A to FIG. 7 at the same time. In FIG. 8, the container feature recognition module 6 is implemented by, for example, a processor executing a special image recognition algorithm. In addition, the details of some steps in FIG. 8 are applicable to the description of FIG. 7, and thus the following description mainly focuses on the differences.

As shown in FIG. 8, step S200 is first executed, in which the image correction module 4 corrects the container image. Then, step S220 is executed, in which the barcode recognition module 5 recognizes the barcode in the container image to obtain a first comparison result, wherein the barcode recognition module 5 may recognize whether the container image has a barcode, and if so, the recognized barcode is compared with the data in the barcode database 81 to generate a first comparison result. This step may be applicable to the description of step S100 in FIG. 7, and thus a detailed description is deemed unnecessary. Then, step S240 is executed, in which the container feature recognition module 6 uses the front image of the container image as the appearance feature and recognizes the appearance feature to obtain a second comparison result, wherein the container feature recognition module 6 may compare the appearance feature with the data in the front image database 82 to recognize the identity information of the container and output a second comparison result, wherein, when the comparison is successful, the second comparison result may include information related to the identity information of the container 2, and when the comparison fails, the second comparison result may include empty data. Then, step S260 is executed, in which the comparison module 7 compares the first comparison result and the second comparison result to determine whether they are matched so as to generate a final result. This step is applicable to the description of step S140 and thus a detailed description is deemed unnecessary. Then, step S280 is executed, in which the comparison module 7 outputs the final result.

In one embodiment, the image correction module 4 may be used to correct the image, wherein the image correction module 4 may determine whether the container image needs to be corrected, and the situation where the container image needs to be corrected includes, for example, image distortion, tilt or blur, etc., but it is not limited thereto. The image correction module 4 may use various suitable image correction methods to correct the image, and the present application is not limited thereto. In one embodiment, before the flow of FIG. 7 begins, step S200 of FIG. 8 (that is, image correction) may also be performed first, but it is not limited thereto. Alternatively, in one embodiment, step S200 may be step to be selectively executed, and thus step S200 may not be executed (that is, image correction is not performed).

In one embodiment, when the container feature recognition module 6 compares the appearance features of the container image with the data in the front image database 82, the container feature recognition module 6 may compare the appearance features of the container image with a plurality of data and select one of the most consistent data as the first comparison result, while it is not limited thereto. Furthermore, the container feature recognition module 6 may preset a threshold value. When the similarity of the comparison is higher than or equal to the threshold value, the data will be used as the content of the second comparison result. In other words, if the similarity of all data comparisons is lower than the threshold value, the empty data will be used as the content of the second comparison result, while it is not limited thereto.

Accordingly, the details of the image recognition method can be understood.

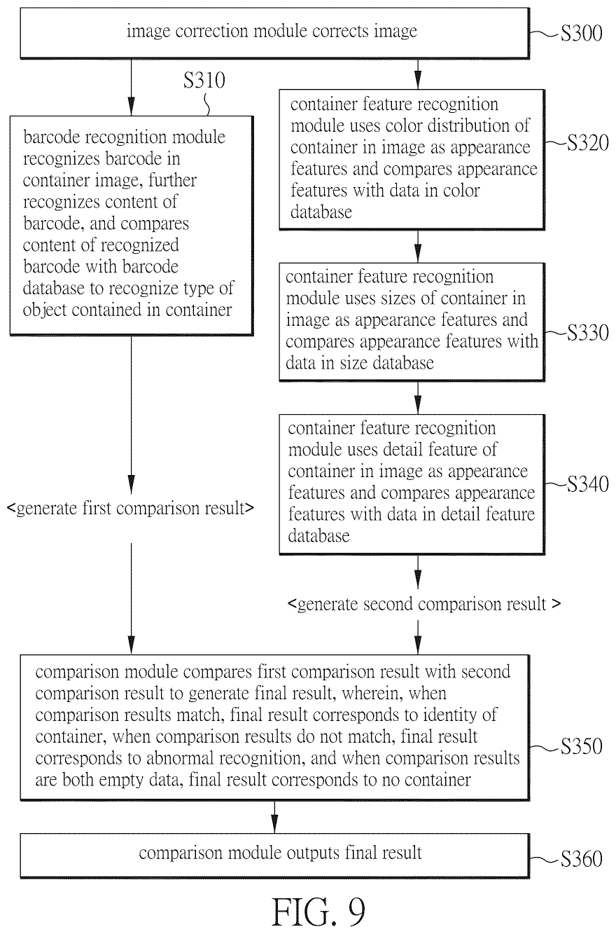

FIG. 9 is a detailed flowchart of an image recognition method according to another embodiment of the present application, which is used to illustrate the details of recognizing one of the container images in step S5, and please refer to FIG. 1A to FIG. 8 at the same time. In FIG. 9, the container feature recognition module 6 is implemented by, for example, a processor executing a special image recognition algorithm. In addition, the details of some steps in FIG. 9 are applicable to the descriptions of FIG. 7 and FIG. 8, and thus the following description mainly focuses on the differences.

As shown in FIG. 9, step S300 is first executed, in which the image correction module 4 corrects the container image. This step is applicable to the description of step S200 in FIG. 8, and thus a detailed description is deemed unnecessary. Then, step S310 is executed, in which the barcode recognition module 5 recognizes the barcode in the container image to obtain a first comparison result, wherein the barcode recognition module 5 recognizes whether there is a barcode in the container image and, if so, compares the recognized barcode with the data in the barcode database 81 to generate a first comparison result. Then, step S320 is executed, in which the container feature recognition module 6 uses the color distribution of the container image (such as color configuration, the proportion of main colors, etc.) as an appearance feature and recognizes the appearance feature, wherein the container feature recognition module 6 may compare the appearance feature with the data in the color database 83 to narrow the recognition range. Then, step S330 is executed, in which the container feature recognition module 6 uses the size of the container image (for example, the height and width of the container 2, or the ratio of the height to width) as the appearance feature and recognizes the appearance feature, wherein the container feature recognition module 6 may compare the appearance feature with the data in the size database 84 to further narrow the recognition range. Then, step S340 is executed, in which the container feature recognition module 6 uses the detail feature of the container image (such as text or logo in a certain area) as the appearance feature and recognizes the appearance feature, wherein the container feature recognition module 6 may compare the appearance feature with the data in the detail feature database 85, and then generate a second comparison result. When the comparison is successful, the second comparison result may include information related to the identity information of the container 2, such as but not limited to the name of the container contents, and when the comparison fails, the second comparison result may include empty data. Then, step S350 is executed, in which the comparison module 7 compares the first comparison result and the second comparison result to determine whether they are matched so as to generate a final result. Then, step S360 is executed, in which the comparison module 7 outputs the final result.

In one embodiment, the execution time of step S320 (that is, the container feature recognition module 6 recognizes the color distribution on the container image of the container 2) may be earlier than the execution time of step S330 (that is, the container feature recognition module 6 recognizes the size of the container image of the container 2) and the execution time of step S340 (that is, the container feature recognition module 6 recognizes the text or logo on the container image of the container 2), so that the time point of recognizing the color distribution of the container 2 will be earlier than the time point of recognizing the size on the container 2 or the time point of recognizing the color distribution of the container 2 will be earlier than the time point of recognizing the text or logo on the container 2, and the execution time of step S330 may be earlier than the execution time of step S340, so that the time point of recognizing the size of the container 2 will be earlier than the time point of recognizing the text or logo on the container 2. In another embodiment, the order of step S320 to step S340 is only an example and may be adjusted according to needs, and the second comparison result may be output in the last step. In addition, one or two steps of step S320 to step S340 may be removed as needed, or other steps may be added or replaced, for example, step S120 in FIG. 7, step S240 in FIG. 8 or other steps may be added or replaced, and the present application is not limited thereto.

In one embodiment, when the container feature recognition module 6 executes any one of step S320 to step S340, the container feature recognition module 6 may compare the appearance features of the container image with a plurality of data and select the most consistent one of the data as the first comparison result, but it is not limited thereto. Furthermore, the container feature recognition module 6 may preset a threshold value, and only when the similarity of the comparison is higher than or equal to the threshold value, the data is output. In other words, if the similarity of all data comparisons is lower than the threshold value, empty data is output, while it is not limited thereto.

Accordingly, the details of the image recognition method can be understood.

In view of the foregoing, it can be seen that the image recognition system 1, image recognition method and image capturing subsystem 3 of the present application may improve the convenience during use. Alternatively, the image recognition system 1, the image recognition method and the image capturing subsystem 3 of the present application may save a lot of time cost. Alternatively, the image recognition system 1, the image recognition method and the image capturing subsystem 3 of the present application may enhance safety.

In one embodiment, the present disclosure may determine whether a product in contention falls within the protection scope of the present disclosure at least by the presence or absence of components, component configurations, mechanism observation and/or operating modes of the product to determine whether it falls within the protection scope of the present disclosure, while it is not limited thereto. Alternatively, the present application may also determine whether the product in contention falls within the protection scope of the present application by the operating mode of the product in contention, or may determine whether the product in contention falls within the protection scope of the present application by the algorithm of the product in contention, but it is not limited thereto. In one embodiment, the algorithm of the product in contention may be obtained, for example, by reverse engineering, but it is not limited thereto.

The details or features of the various embodiments of the present application may be mixed and matched as long as they do not violate the spirit of the invention or conflict with each other.

The aforementioned specific embodiments should be interpreted as merely illustrative, and not limiting the rest of the present application in any way, and the features of different embodiments may be mixed and matched as long as they do not conflict with each other.

1. An image recognition system adapted to recognize a plurality of containers, comprising:
an image capturing component for acquiring a plurality of images, wherein each image includes a picture of the plurality of containers at a different angle;
a barcode recognition module for obtaining a first comparison result by recognizing barcodes on the plurality of containers in the plurality of images;
a container feature recognition module for obtaining a second comparison result by recognizing appearance features of the plurality of containers in the plurality of images; and
a comparison module for comparing the first comparison result with the second comparison result to detect whether the first comparison result and the second comparison result match so as to generate a final result.

2. The image recognition system as claimed in claim 1, further comprising an image correction module for correcting the plurality of images.

3. The image recognition system as claimed in claim 1, wherein the appearance features of the plurality of containers include text or logo on the plurality of containers.

4. The image recognition system as claimed in claim 3, wherein the appearance features of the plurality of containers further include sizes of the plurality of containers, and wherein a time point at which the container feature recognition module recognizes the sizes of the plurality of containers is earlier than a time point at which the container feature recognition module recognizes the text or logo on the plurality of containers.

5. The image recognition system as claimed in claim 3, wherein the appearance features of the plurality of containers further include color distribution of the plurality of containers in the plurality of images, and wherein a time point at which the container feature recognition module recognizes the color distribution of the plurality of containers is earlier than a time point at which the container feature recognition module recognizes the text or logo on the plurality of containers.

6. An image recognition method adapted to recognize a plurality of containers, the method being performed by an image recognition system including an image capturing component, a barcode recognition module, a container feature recognition module and a comparison module, and comprising the steps of:
using the image capturing component to acquire a plurality of images, wherein each image includes a picture of the plurality of containers at a different angle;
using the barcode recognition module to recognize barcodes on the plurality of containers in the plurality of images so as to obtain a first comparison result;
using the container feature recognition module to recognize appearance features of the plurality of containers in the plurality of images so as to obtain a second comparison result; and
using the comparison module to compare the first comparison result with the second comparison result so as to detect whether the first comparison result and the second comparison result match, thereby generating a final result.

7. The image recognition method as claimed in claim 6, wherein the image recognition system further includes an image correction module for correcting the plurality of images.

8. The image recognition method as claimed in claim 6, wherein the appearance features of the plurality of containers include text or logo on the plurality of containers.

9. The image recognition method as claimed in claim 8, wherein the appearance features of the plurality of containers further include sizes of the plurality of containers, and wherein a time point at which the container feature recognition module recognizes the sizes of the plurality of containers is earlier than a time point at which the container feature recognition module recognizes text or logo on the plurality of containers.

10. The image recognition method as claimed in claim 8, wherein the appearance features of the plurality of containers further include color distribution of the plurality of containers in the plurality of images, and wherein a time point at which the container feature recognition module recognizes the color distribution of the plurality of containers is earlier than a time point at which the container feature recognition module recognizes the text or logo on the plurality of containers.

11. An image capturing subsystem, comprising:
a rack assembly including a plurality of support racks arranged into an N-hedron, wherein N is a positive integer greater than or equal to 4, and each of the plurality of support racks has a plurality of carriers, on each of which a container is placed;
a driving component for rotating the plurality of carriers to rotate the container; and
an image capturing component for photographing the container placed on each of the plurality of carriers of one of the plurality of support racks.

12. The image capturing subsystem as claimed in claim 11, wherein the N-hedron formed by arrangement of the plurality of support racks is rotatable so that a shortest distance between any one of the plurality of support racks and the image capturing component is equal.

13. The image capturing subsystem as claimed in claim 11, wherein the driving component rotates the rack assembly so that one of the plurality of support racks faces the image capturing component.

14. The image capturing subsystem as claimed in claim 11, wherein each support rack has a plurality of shelves, and each shelf is provided with a plurality of carriers.

15. The image capturing subsystem as claimed in claim 14, wherein the driving components includes a plurality of sub-driving components, and each sub-driving component is operated in conjunction with a carrier on a shelf.

16. The image capturing subsystem as claimed in claim 14, wherein each carrier has a carrier plane and a carrier rotation shaft, and the carrier rotation shaft is disposed below the carrier plane.

17. The image capturing subsystem as claimed in claim 16, wherein each shelf includes a plurality of holes, and a size of each hole is larger than that of the carrier rotation shaft and smaller than that of the carrier plane.

18. The image capturing subsystem as claimed in claim 17, wherein the carrier rotation shaft passes through the hole of the shelf through a bearing and is combined with the sub-driving component below the shelf through another bearing.

19. The image capturing subsystem as claimed in claim 14, wherein a plurality of sub-driving components under the same shelf are sleeved with a timing belt.

20. The image capturing subsystem as claimed in claim 14, wherein the driving component drives the rack assembly to rotate so that one of the support racks of the rack assembly faces the image capturing component, and an image capturing range of the image capturing component covers the containers on at least one shelf of one of the support racks.
